(19) United States
(12) Patent Application Publication
(10) Pub. No.: US 2019/0132282 A1
(43) Pub. Date: May 2, 2019

(54) NDN AND IP FUSION NETWORK CONTENT CONTROL METHOD AND APPARATUS, AND STORAGE MEDIUM

(71) Applicant: PEKING UNIVERSITY SHENZHEN GRADUATE SCHOOL, Shenzhen (CN)

(72) Inventors: Kai LEI, Shenzhen (CN); Shuai ZHU, Shenzhen (CN); Shangru ZHONG, Shenzhen (CN); Zhuyun QI, Shenzhen (CN); Yi ZHANG, Shenzhen (CN)

(73) Assignee: PEKING UNIVERSITY SHENZHEN GRADUATE SCHOOL, Shenzhen (CN)

(21) Appl. No.: 16/094,843

(22) PCT Filed: Aug. 11, 2017
(86) PCT No.: PCT/CN2017/096996

§ 371 Date: Oct. 18, 2018

(51) Int. Cl. H04L 29/12; H04L 29/06; H04L 29/08

(52) U.S. Cl. CPC H04L 61/1511; H04L 69/08; H04L 61/2076; H04L 61/6009; H04L 67/327; H04L 65/608; H04L 63/0245; H04L 61/3015

(57) ABSTRACT

An NDN and IP fusion network content control method and apparatus. The method comprises: obtaining a request packet issued by a client in a TCP/IP network; performing application layer protocol deep packet analysis on the request packet; upon determining that the request packet is a request packet which satisfies a first type target site, determining a replacement content name according to a pre-established name mapping table; according to the replacement content name and request content of the request packet in the TCP/IP network, generating an interest packet in an NDN protocol format, and forwarding to an NDN network; obtaining a data packet in the NDN protocol format returned after the interest packet in the NDN protocol format was forwarded to the NDN network; converting the data packet in the NDN protocol format into a data packet in an IP protocol format, and returning to the client in the TCP/IP network. The present invention implements content granularity level content control, and modifies or replaces content for return to a user, something which cannot be achieved in traditional TCP/IP networks.

### TECHNICAL FIELD

The present disclosure relates to network communication, and in particular, to methods and apparatus for content management and control of hybrid network of NDN and IP.

### BACKGROUND OF THE INVENTION

Internet users are generating and delivering web content every day in the era of Web 2.0, so it is necessary to properly manage and control web content. Under the existing TCP/IP network architecture, content is filtered with coarse granular through common methods including DNS cache pollution and IP block; in other words, content to be managed and controlled is generally blocked directly in prior art.

### SUMMARY OF THE INVENTION

A method and an apparatus for content management and control of a hybrid network of NDN and IP provided in the present disclosure may realize finer-grained content management and control; that is, replacing or modifying content to be managed and controlled before returning the content to a user client, rather than directly blocking it.

According to a first aspect, a method for content management and control of a hybrid network of NDN and IP provided by an embodiment may include steps of:

capturing a request packet sent by a client in TCP/IP network;

performing deep packet inspection of application layer on the request packet to determine whether the request packet is conformed to a first-type target website;

determining the name of replacement content according to a pre-established naming mapping table when it is determined that the request packet is conformed to the first-type target website, wherein the replacement content is used for replacing requested content of the request packet in TCP/IP network;

generating an Interest packet in NDN protocol format according to the name of replacement content and the request content of the request packet in TCP/IP network, and forwarding it to an NDN network;

acquiring a Data packet in NDN protocol format returned after the Interest packet in NDN protocol format forwarded to the NDN network; and

converting the Data packet in NDN protocol format into a Data packet in IP protocol format, and returning it to the client in TCP/IP network.

In an embodiment, the method may further include forwarding the request packet directly in TCP/IP network when it is determined that the request packet is not conformed to the first-type target website.

According to a second aspect, a method for content management and control of a hybrid network of NDN and IP provided by an embodiment may include steps of:

capturing a content Data packet returned by a server in TCP/IP network;

performing deep packet inspection on the content data packet to determine whether the content data packet is a response message returned by a first-type target website;

when it is determined that the content data packet is a response message returned by a first-type target website, performing a judgment that whether the content data packet contains prohibited content;

when it is determined that the content data packet contains prohibited content, determining the name of replacement content according to a pre-established name-mapping table, wherein the replacement content is used for replacing the content contained in the content data packet;

generating an Interest packet in the format of NDN protocol according to the name of the replacement content and the content data packet, and forwarding the Interest packet to NDN network;

acquiring a Data packet in the format of NDN protocol returned after the Interest packet of in the format of NDN protocol is forwarded to NDN network; and

converting the Data packet in the format of NDN protocol into a Data packet in the format of IP protocol and returning it to the client in the TCP/IP network according to the destination address returned by the server.

In an embodiment, the method may further include: when it is determined that the content data packet is not a response message returned by the first-type target website, or it is determined that the content data packet does not contain prohibited content, returning the content data packet directly in TCP/IP network to a client in the TCP/IP network according to a destination address returned by the server.

In an embodiment, the server is a streaming media server, and the content data packet is data about a video streaming protocol.

In an embodiment, the method may further include:

performing deep packet inspection of the application layer to the captured request packet to determine whether the request packet is conformed to a second-type target website, wherein the request packet is sent by a client in TCP/IP network;

when it is determined that the request packet is conformed to the second-type target website, converting the request packet into an Interest packet in NDN protocol format and forwarding it to the NDN network; otherwise, forwarding the request packet directly in TCP/IP network;

when a Data packet in NDN protocol format returned after the Interest packet in NDN protocol format is forwarded to the NDN network is acquired, converting the acquired Data packet in NDN protocol format into a Data packet in IP protocol format and returning it to the client in TCP/IP network; otherwise, re-forwarding the request packet in TCP/IP network; and

when the request packet is forwarded in TCP/IP network, capturing a Data packet returned as a response of the server when the request packet is forwarded in TCP/IP network; and returning the returned Data packet to the client, converting the returned Data packet into a Data packet in NDN protocol format and buffering it locally on a nearest NDN node.

According to a third aspect, an apparatus for content management and control of a hybrid network of NDN and IP provided by an embodiment may include:

an NDN/IP gateway configured for capturing a request packet sent by a client in TCP/IP network; performing deep packet inspection of application layer on the request packet to determine whether the request packet is conformed to a first-type target website; determining the name of replacement content according to a pre-established naming mapping table when it is determined that the request packet is conformed to the first-type target website, wherein the replacement content is used for replacing requested content of the request packet in TCP/IP network; and forwarding the request packet directly in TCP/IP network when it is determined that the request packet is not conformed to the first-type target website; and

an NDN/IP conversion unit configured for generating an Interest packet in NDN protocol format according to the name of replacement content and the request content of the request packet in TCP/IP network, and forwarding it to an NDN network; acquiring a Data packet in NDN protocol format returned after the Interest packet in NDN protocol format forwarded to the NDN network; and converting the Data packet in NDN protocol format into a Data packet in IP protocol format, and returning it through the NDN/IP gateway to the client in TCP/IP network.

According to a fourth aspect, an apparatus for content management and control of a hybrid network of NDN and IP provided by an embodiment may include:

an NDN/IP gateway configured for capturing a content Data packet returned by a server in TCP/IP network; performing deep packet inspection on the content data packet to determine whether the content data packet is a response message returned by a first-type target website; when it is determined that the content data packet is a response message returned by a first-type target website, performing a judgment that whether the content data packet contains prohibited content; when it is determined that the content data packet contains prohibited content, determining the name of replacement content according to a pre-established name-mapping table, wherein the replacement content is used for replacing the content contained in the content data packet; and when it is determined that the content data packet is not a response message returned by the first-type target website, or it is determined that the content data packet does not contain prohibited content, returning the content data packet directly in TCP/IP network to a client in the TCP/IP network according to a destination address returned by the server; and

an NDN/IP conversion unit configured for generating an Interest packet in the format of NDN protocol according to the name of the replacement content and the content data packet, and forwarding the Interest packet to NDN network; acquiring a Data packet in the format of NDN protocol returned after the Interest packet of in the format of NDN protocol is forwarded to NDN network; and converting the Data packet in the format of NDN protocol into a Data packet in the format of IP protocol and returning it to the client in the TCP/IP network according to the destination address returned by the server.

In an embodiment, the NDN/IP gate is used for capturing a video stream returned by a streaming media server in TCP/IP network.

According to a fifth aspect, a storage medium provided in an embodiment may include a program executable by a processor to implement the method for content management and control according to any one of the above-mentioned embodiments.

With the method and the apparatus for content management and control of a hybrid network of NDN and IP, as well as the storage medium of the aforesaid embodiments, content management and control of various content granular levels can be achieved, and the content can be returned to the user after being modified or replaced, which cannot be done in a traditional TCP/IP network.

### BRIEF DESCRIPTION OF THE DRAWINGS

FIG. 1 is a flowchart of a method for content management and control of a hybrid network of NDN and IP according to an embodiment;

FIG. 2 is a schematically structural view of an apparatus for content management and control of a hybrid network of NDN and IP according to an embodiment;

FIG. 3 is a flowchart of a method for content management and control of a hybrid network of NDN and IP according to another embodiment;

FIG. 4 is a schematically structural view of an apparatus for content management and control of a hybrid network of NDN and IP according to another embodiment;

FIG. 5 is a flowchart of a method for content management and control of a hybrid network of NDN and IP according to still another embodiment.

### DETAILED DESCRIPTION

The present disclosure will be further described in detail below with reference to the accompanying drawings. Like reference numbers may be employed to indicate associated similar elements in different embodiments.

In the following embodiments, many details are described in order to provide a better understanding of the disclosure. However, those skilled in the art can easily realize that some of the features may be omitted in different situations, or may be replaced by other components, materials, and manners. In some cases, some operations related to the present disclosure are not shown or described in the specification, which is for avoiding the core of the present disclosure be overwhelmed by excessive description, and for those skilled in the art, it is not necessary to describe these in detail. They can fully understand the relevant operations according to the description in the specification and the general technical knowledge in the field.

In addition, the features, operations, or characteristics described in the specification may be combined in any suitable manner to form various embodiments. At the same time, the steps or actions in the described methods can also be sequentially changed or adjusted in a manner that can be apparent to those skilled in the art. Accordingly, the various sequences in the specification and the drawings are only for the purpose of describing a particular embodiment, and are not intended to be a necessary order, unless otherwise specified.

The serial numbers for the elements herein, such as “first”, “second”, etc., are only used to distinguish the described items, and do not have any order or technical meaning. As used herein, “connect”, “couple”, etc., unless otherwise specified, may include both direct and indirect connections.

In order to make the present disclosure clearer, an explanation is first given to the NDN network. Information-Center Network (ICN), a future Internet architecture, has attempted to replace the traditional TCP/IP-based protocol in recent years. In ICN, users only concern quick acquiring data (or copies) by any network node, rather than the location of content. Named Data Networking (NDN) is typical in this regard. In NDN, all the data is name-identified, and IP-address and communication link are no longer existed in the network. The network communication is based on two types of packets: Interest packet and Data packet, which are matched on their full or relative names. The Interest packet is used to request data in the network by a data requestor, and the Data packet is the data returned by a data owner after receiving the request. NDN is a pull-based architecture, in which data is requested by sending Interest packets by a consumer, corresponding Data packets are returned along the same path; and good content distribution is achieved through a built-in caching function and flexible forwarding strategy layer. NDN's content-oriented network transport capabilities enable it to be used for content distribution of a massive amount of data.

It is not realistic to deploy NDN, a novel type of future network architecture, in the real world in a short period of time and replace the TCP/IP network architecture; accordingly, solutions of TCP/IP to NDN have been studied in academic community during the transitional period. A hybrid network of TCP/IP and NDN reckoned by the inventor is one of them. It may be an integration scheme of vertically upper and lower layers, in which NDN network is directly overlaying on IP, and NDN packet served as Application Layer data is encapsulated in IP Data packet; and it may also be a horizontally integration scheme in which IP-NDN translation is based on protocol parsing, and an IP packet or NDN packet is extracted and then converted into another protocol format.

In the present disclosure, the capture, detection and analysis of data packets of network specific content (such as streaming media) can be implemented according to the technology of deep packet inspection (DPI), and protocol conversion between IP network packet and NDN network packet can be realized based on the IP-NDN protocol conversion, thus providing a hybrid network scenario of NDN and IP, and further providing a management and control method by using NDN content-aware capabilities to implement a management and control method for replacement and modification of content level (more fine-grained). Such management and control method may not only enable a more fine-grained content replacement or modification in traditional TCP/IP networks (URL-based filtering), but also support, in some embodiments, management and control of streaming media content that cannot be solved by traditional management of TCP/IP. The DPI technology is one for detecting and processing network data packets at Application Layer; with the technology, traffic and packet content of a network backbone router can be detected and analyzed, and filtering the content of packets can be implemented according to a defined rule strategy, thus achieving capabilities including traffic analysis statistics and anti-application-layer attacks.

The present disclosure will be illustrated by the following embodiments with reference to the accompanying drawings.

### First Embodiment

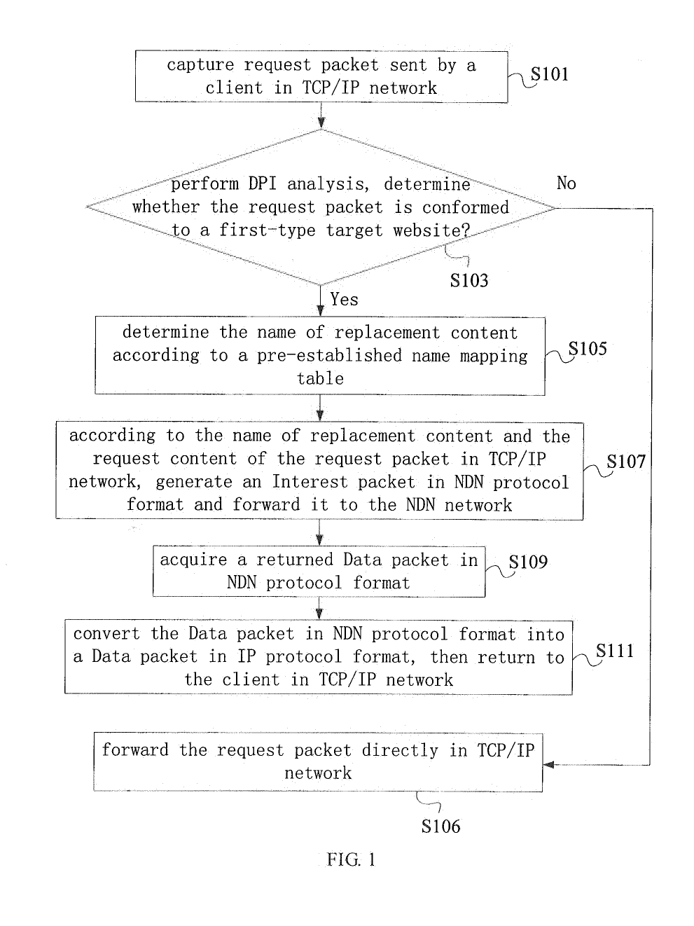

Referring to FIG. 1, a method for content management and control of a hybrid network of NDN and IP is disclosed in this embodiment. The method includes steps S101 to S111, which are specifically described below.

Step S101: capturing a request packet sent by a client in TCP/IP network.

Step S103: performing deep packet inspection of the application layer to the request packet to determine whether the request packet is conformed to a first-type target website. When it is determined that the request packet is conformed to the first-type target website, proceeding to step S105; otherwise, proceeding to step S106, and forwarding the request packet directly in the TCP/IP network.

Step S105: when it is determined that the request packet is conformed to the first-type target website, determining a replacement content name according to a pre-established name-mapping table, wherein the replacement content is used for replacing requested content of the request packet in TCP/IP network. In an embodiment, the pre-established name-mapping table may be an illegal website URL mapped into a legal (video) content name, or an illegal (video) content name to a legal (video) content name.

Step S107: generating an Interest packet in NDN protocol format according to the name of the replacement content and the request content of the request packet in TCP/IP network, and forwarding the Interest packet to an NDN network.

Step S109: acquiring a Data packet in NDN protocol format returned after the Interest packet in NDN protocol format forwarded to the NDN network.

Step S111: converting the Data packet in NDN protocol format into a Data packet in IP protocol format, and returning it to the client in TCP/IP network.

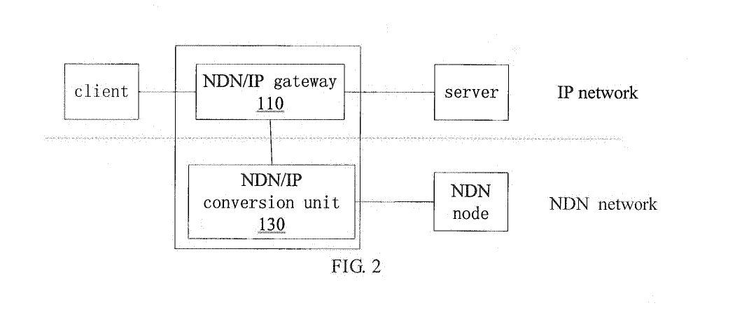

Referring to FIG. 2, an apparatus for content management and control of a hybrid network of NDN and IP is further provided in this embodiment. The apparatus includes an NDN/IP gateway 110 and an NDN/IP conversion unit 130, which are specifically described below.

The NDN/IP gateway 110 is used for: capturing a request packet sent by a client in TCP/IP network; performing deep packet inspection of application layer on the request packet to determine whether the request packet is conformed to a first-type target website; determining the name of replacement content according to a pre-established name-mapping table when it is determined that the request packet is conformed to the first type of target website, wherein the replacement content is used for replacing requested content of the request packet in TCP/IP network; and forwarding the request packet directly in TCP/IP network when it is determined that the request packet is not conformed to the first type of target website.

The NDN/IP conversion unit 130 is used for: generating an Interest packet in NDN protocol format according to the name of the replacement content and the request content of the request packet in TCP/IP network, and forwarding the Interest packet to an NDN network; acquiring a Data packet in NDN protocol format returned after the Interest packet in NDN protocol format forwarded to the NDN network; and converting the Data packet in NDN protocol format into a Data packet in IP protocol format, and returning it to the client in TCP/IP network through the NDN/IP gateway 110.

Another example is provided to further describe the method and the apparatus for content management and control of a hybrid network of NDN and IP according to this embodiment below.

For example, it may be possible to take a scenario in which video content at a streaming server “http://youtube.com” is requested by an IP user via a video-on-demand service to illustrate. The request packet sent by the client in TCP/IP network may contain video content of forbidden information, such as “http://youtube.com/invalid_video/seg_1/chunk_1/”. It should be noted that the prohibition information can be predefined, such as some sensitive information or information that violates relevant laws or regulations. The first type of target website includes “http://youtube.com”, so when the NDN/IP gateway 110 captures the above request packet, the request packet is determined to be one conformed to the first type of target website, and the name of replacement content is determined according to a pre-established name-mapping table, for instance, mapping the above domain name “http://youtube.com/invalid_video/seg_1/chunk_1/” to the name “/youtube.com/valid_video/seg_1/chunk I”. Next, the NDN/IP conversion unit 130 may generate an Interest packet in NDN protocol format according to the name of the replacement content and the requested content of the request packet in TCP/IP network, and may forward the Interest packet to an NDN network. The NDN/IP conversion unit 130 may further acquire a Data packet in NDN protocol format returned after the Interest packet in NDN protocol format forwarded to the NDN network, convert the Data packet in NDN protocol format into a Data packet in IP protocol format, and return it to the client in TCP/IP network through the NDN/IP gateway 110. Therefore, with the present disclosure, content management and control of various content granularity levels can be achieved, and the content can be returned to the user after being modified or replaced, which is not possible in a traditional TCP/IP network.

### Second Embodiment

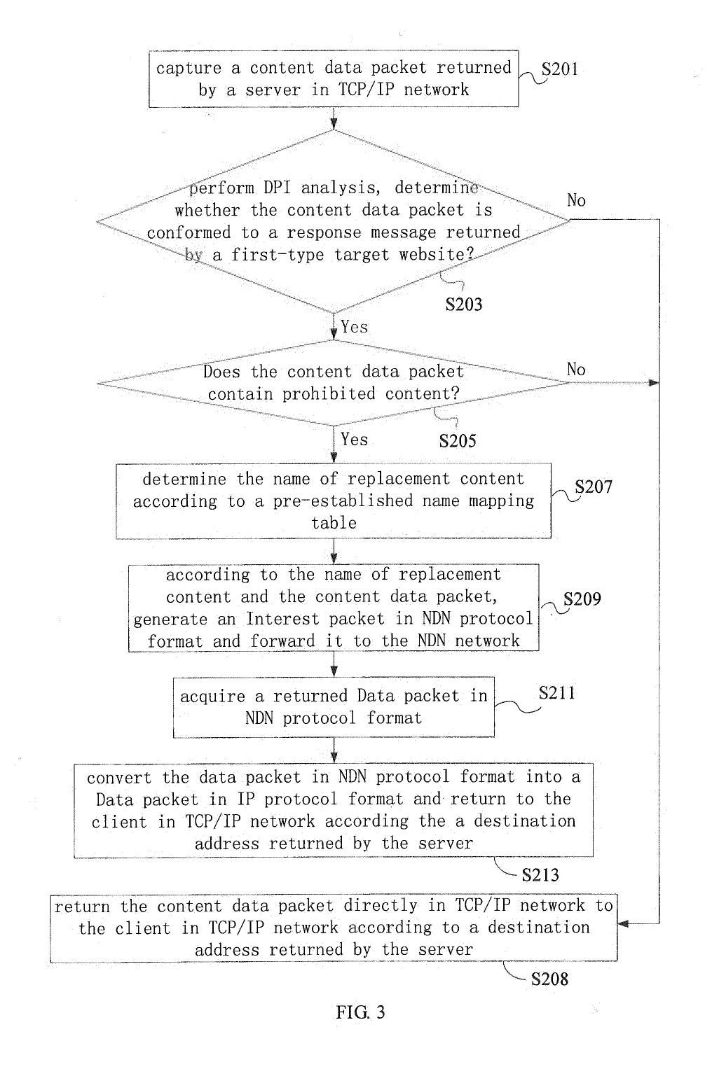

Referring to FIG. 3, a method for content management and control of a hybrid network of NDN and IP is disclosed in this embodiment. The method includes steps S201 to S213, which are specifically described below.

Step S201: capturing a content data packet returned by a server in TCP/IP network. In an embodiment, the server is a streaming media server, and the content data packet is data about a video streaming protocol; in other words, a video stream returned by the streaming media server in TCP/IP network is captured in step S201.

Step S203: performing deep packet inspection on the content data packet to determine whether the content data packet is a response message returned by a first-type target website.

Step S205: when it is determined that the content data packet is a response message returned by a first-type target website, performing a judgment that whether the content data packet contains prohibited content. In an embodiment, the prohibited content may be defined by a preset, such as some sensitive content or content that violates relevant laws or regulations.

Step S207: when it is determined that the content data packet contains prohibited content, determining the name of replacement content according to a pre-established name-mapping table, wherein the replacement content is used for replacing the content contained in the content data packet. In an embodiment, the pre-established name-mapping table may include an illegal website URL mapped into a legal (video) content name, or an illegal (video) content name mapped into a legal (video) content name.

Step S208: when it is determined that the content data packet is not a response message returned by the first-type target website, or it is determined that the content data packet does not contain prohibited content, the content data packet is directly returned in TCP/IP network to a client in TCP/IP network according to a destination address returned by the server.

Step S209: generating an Interest packet in NDN protocol format according to the name of the replacement content and the content data packet, and forwarding the Interest packet to NDN network.

Step S211: acquiring a Data packet in NDN protocol format returned after the Interest packet of in NDN protocol format is forwarded to an NDN network.

Step S213: converting the Data packet in NDN protocol format into a Data packet in the format of IP protocol and returning it to the client in TCP/IP network according to the destination address returned by the server.

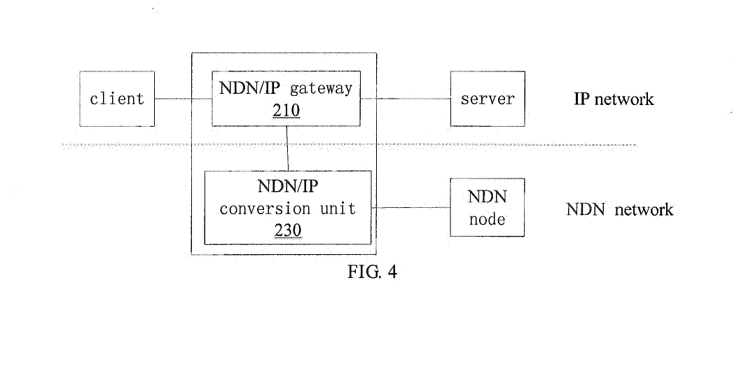

Referring to FIG. 4, an apparatus for content management and control of a hybrid network of NDN and IP is further provided in this embodiment. The apparatus includes an NDN/IP gateway 210 and an NDN/IP conversion unit 230, which are specifically described below.

The NDN/IP gateway 210 is used for: capturing a content data packet returned by a server in TCP/IP network; performing deep packet inspection on the content data packet to determine whether the content data packet is a response message returned by a first-type target website; when it is determined that the content data packet is a response message returned by a first-type target website, performing a judgment that whether the content data packet contains prohibited content; when it is determined that the content data packet contains prohibited content, determining the name of replacement content according to a pre-established name-mapping table, wherein the replacement content is used for replacing the content contained in the content data packet; and when it is determined that the content data packet is not a response message returned by the first-type target website, or it is determined that the content data packet does not contain prohibited content, the content data packet is directly returned in TCP/IP network to a client in TCP/IP network according to a destination address returned by the server. In an embodiment, in the content data packet returned by the server in TCP/IP network and captured by the NDN/IP gateway 210, the server a streaming media server, and the content data packet is data about a video streaming protocol; in other words, a video stream returned by the streaming media server in TCP/IP network is captured by the NDN/IP gateway 210.

The NDN/IP conversion unit 230 is used for: generating an Interest packet in NDN protocol format according to the name of the replacement content and the content data packet, and forward the Interest packet to an NDN network; acquiring a Data packet in NDN protocol format returned after the Interest packet of in NDN protocol format is forwarded to the NDN network; and converting the Data packet in NDN protocol format into a Data packet in the format of IP protocol and returning it to the client in TCP/IP network according to the destination address returned by the server.

Another example is provided to further describe the method and the apparatus for content management and control of a hybrid network of NDN and IP according to this embodiment below.

For example, it may be possible to take a scenario in which video content at a streaming server “http://youtube.com” is requested by an IP user via a video-on-demand service to illustrate. The NDN/IP gateway 210 captures a video stream returned by a streaming media server and performs deep packet inspection on the video stream. When it is determined that the video stream is a response message returned by a first-type target website and the video stream contains prohibited content, the name of replacement content may be determined according to a pre-established name-mapping table, for example, mapping “http://youtube.com/movie/seg_2/invalid_chunk_1” into “youtube.com/movie/seg_2/valid_chunk_1”.

Then, the NDN/IP conversion unit 230 may generate an Interest packet in NDN protocol format according to the name of the replacement content and the content data packet, and forward the Interest packet to the NDN network. The NDN/IP conversion unit 230 may acquire a Data packet in NDN protocol format returned after the Interest packet in NDN protocol format is forwarded to the NDN network, and convert the Data packet in NDN protocol format into a Data packet in the format of IP protocol and returning it to the client in TCP/IP network according to the destination address returned by the server. Therefore, with the present disclosure, content management and control of various content granularity levels can be achieved, and the content can be returned to the user after being modified or replaced; for example, some illegal content can be replaced by the video stream, specifically, an illegal section in a movie can be replaced; which is not possible in a traditional TCP/IP network.

### Third Embodiment

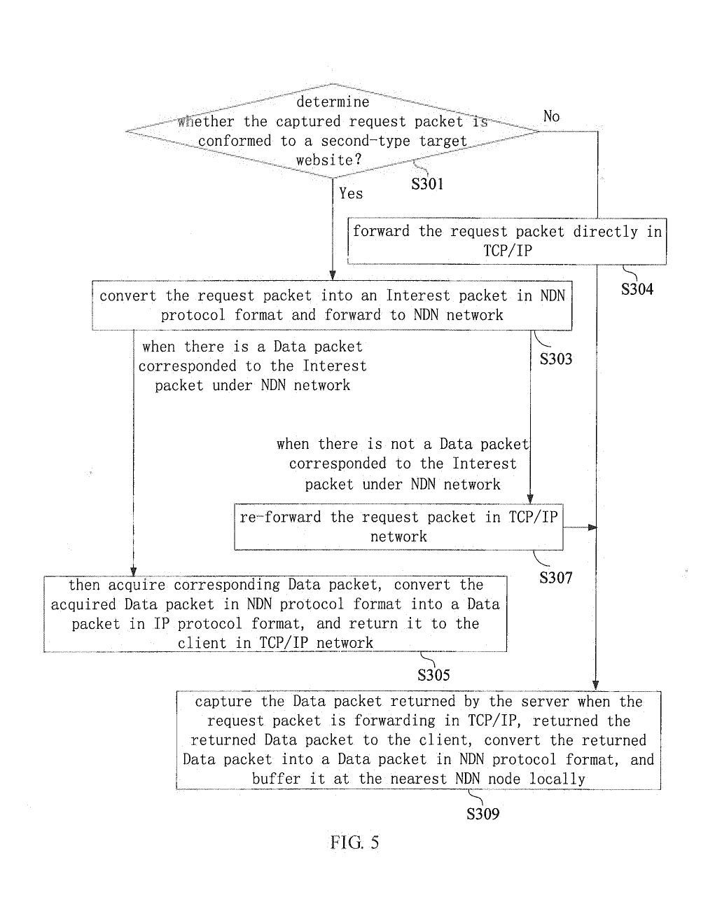

On the basis of the first embodiment or the second embodiment, referring to FIG. 5, a method for content management and control of a hybrid network of NDN and IP disclosed in the third embodiment may further include the following steps S301-S309.

Step S301: performing deep packet inspection of the application layer to the captured request packet to determine whether the request packet is conformed to a second-type target website; wherein the request packet is sent by a client in TCP/IP network. When it is determined that the request packet is conformed to the second-type target website, proceeding to step S303; otherwise, proceeding to step S304, and the request packet is directly forwarded in TCP/IP network.

Step S303: when it is determined that the request packet is conformed to the second-type target website, converting the request packet into an Interest packet in NDN protocol format and forwarding it to the NDN network.

Step S305: when there is a Data packet corresponded to the Interest packet in NDN protocol format over the NDN network, acquiring a Data packet in NDN protocol format returned after the Interest packet in NDN protocol format is forwarded to the NDN network, then converting the acquired Data packet in NDN protocol format into a Data packet in IP protocol format and returning it to the client in TCP/IP network.

Step S307: when there isn't a Data packet corresponded to the Interest packet in NDN protocol format over the NDN network, re-forwarding the request packet in TCP/IP network.

Step S309: when the request packet is forwarded in TCP/IP network in step S304 or step S307, capturing a Data packet returned as a response of the server when the request packet is forwarded in TCP/IP network, returning the returned Data packet to the client, and converting the returned Data packet into a Data packet in NDN protocol format and buffering it locally on a nearest NDN node.

On the basis of the first embodiment or the second embodiment, an apparatus for content management and control of a hybrid network of NDN and IP disclosed in the third embodiment may include an NDN/IP gateway and an NDN/IP conversion unit. The NDN/IP gateway and the NDN/IP conversion unit may further include the following structures and functions.

The NDN/IP gateway is used for: performing deep packet inspection of the application layer to the captured request packet to determine whether the request packet is conformed to a second-type target website, wherein the request packet is sent by a client in TCP/IP network; when it is determined that the request packet is conformed to the second-type target website, converting the request packet into an Interest packet in NDN protocol format and forwarding it to the NDN network; otherwise, directly forwarding the request packet in TCP/IP network.

The NDN/IP conversion unit is used for: when a Data packet in NDN protocol format returned after the Interest packet in NDN protocol format is forwarded to the NDN network is acquired, converting the acquired Data packet in NDN protocol format into a Data packet in IP protocol format and returning it to the client in TCP/IP network; otherwise, re-forwarding the request packet in TCP/IP network through the NDN/IP gateway.

When the request packet is forwarded in TCP/IP network, the NDN/IP gateway may capture a Data packet returned as a response of the server when the request packet is forwarded in TCP/IP network; and returning the returned Data packet to the client, the NDN/IP conversion unit may convert the returned Data packet into a Data packet in NDN protocol format and buffering it locally on a nearest NDN node.

With this embodiment, content acceleration and caching can be implemented.

The above describes several embodiments of the present disclosure. With the present disclosure, sensitive content data packets requested by users under IP network are converted into NDN network and part of the content is replaced, and replacement and management for the level of content can be achieved. In the present disclosure, by means of content-aware feature of NDN, traffic hijack and content caching of specific website can be implemented based on the NDN/IP gateway, thereby realizing content caching and replacement management on a TCP/IP network such as HTTP.

For example, a Data packet containing sensitive or illegal content requested by an IP user may pass through the NDN/IP gateway, and the illegal request packet may be identified and hijacked by DPI, then the name of legal video blocks used as replacement may be determined according to a name mapping table, following from that, the packet and the name are translated by the NDN/IP conversion unit into an Interest packet having replaced legal content and transferred to the NDN network, returning a legal video content. For example, a network video packet returned by the streaming media server may be intercepted by the NDN/IP gateway at the network backbone, and illegal video blocks (segments or frames) in the video packet may be recognized by deep learning or the like; the name of legal video blocks used as replacement may be determined according to a name mapping table; then the packet and the name are translated by the NDN/IP conversion unit into an Interest packet to be transferred into the NDN network; after intra-network cache hit the target in an NDN routing node, legal video blocks are returned, the replaced network video packet containing the legal video block is reassembled at the NDN/IP gateway and then returned to the user.

Therefore, with the present disclosure, content aware for the level granularity of content can be realized, illegal content blocks can be filtered and returned, achieving the replacement of some video content.

Those skilled in the art can understand that all or part of the functions of the various methods in the above embodiments may be implemented by hardware or by a computer program. When all or part of the functions in the above embodiments are implemented by a computer program, the program may be stored in a computer readable storage medium which may include: a read only memory, a random access memory, a magnetic disk, an optical disk, a hard disk, and the like and be executed to implement the above functions. For example, the program is stored in the memory of the device, and when the program in the memory is executed by the processor, all or part of the above functions can be realized. In addition, when all or part of the functions in the above embodiments are implemented by a computer program, the program may also be stored in a storage medium such as a server, another computer, a magnetic disk, an optical disk, a flash drive, or a mobile hard disk, and saved in a memory locally by downloading or copying, or be used to update the version of the system locally. When the program in the memory is executed by the processor, all or part of the functions in the above embodiments may be implemented.

The principle and embodiments of the present disclosure are described with reference to the specific examples hereinabove. The embodiments above are merely used to facilitate understanding the present disclosure, but should not be interpreted as limitations to the present disclosure. For a person ordinarily skilled in the art, variations to the specific embodiments above may be made according to the concept of the present disclosure.

What is claimed is:

1. A method for content management and control of a hybrid network of NDN and IP, comprising:
capturing a request packet sent by a client in TCP/IP network;
performing deep packet inspection of application layer on the request packet to determine whether the request packet is conformed to a first-type target website;
determining the name of replacement content according to a pre-established naming mapping table when it is determined that the request packet is conformed to the first-type target website, wherein the replacement content is used for replacing requested content of the request packet in TCP/IP network;
generating an Interest packet in NDN protocol format according to the name of replacement content and the request content of the request packet in TCP/IP network, and forwarding it to an NDN network;
acquiring a Data packet in NDN protocol format returned after the Interest packet in NDN protocol format forwarded to the NDN network; and
converting the Data packet in NDN protocol format into a Data packet in IP protocol format, and returning it to the client in TCP/IP network.

2. The method for content management and control according to claim 1, further comprising: forwarding the request packet directly in TCP/IP network when it is determined that the request packet is not conformed to the first-type target website.

3. A method for content management and control of a hybrid network of NDN and IP, comprising:
capturing a content Data packet returned by a server in TCP/IP network;
performing deep packet inspection on the content data packet to determine whether the content data packet is a response message returned by a first-type target website;
when it is determined that the content data packet is a response message returned by a first-type target website, performing a judgment that whether the content data packet contains prohibited content;
when it is determined that the content data packet contains prohibited content, determining the name of replacement content according to a pre-established name-mapping table, wherein the replacement content is used for replacing the content contained in the content data packet;
generating an Interest packet in the format of NDN protocol according to the name of the replacement content and the content data packet, and forwarding the Interest packet to NDN network;
acquiring a Data packet in the format of NDN protocol returned after the Interest packet of in the format of NDN protocol is forwarded to NDN network; and
converting the Data packet in the format of NDN protocol into a Data packet in the format of IP protocol and returning it to the client in the TCP/IP network according to the destination address returned by the server.

4. The method for content management and control according to claim 3, further comprising: when it is determined that the content data packet is not a response message returned by the first-type target website, or it is determined that the content data packet does not contain prohibited content, returning the content data packet directly in TCP/IP network to a client in the TCP/IP network according to a destination address returned by the server.

5. The method for content management and control according to claim 3, wherein the server is a streaming media server, and the content data packet is data about a video streaming protocol.

6. The method for content management and control according to claim 1, further comprising:
performing deep packet inspection of the application layer to the captured request packet to determine whether the request packet is conformed to a second-type target website, wherein the request packet is sent by a client in TCP/IP network;
when it is determined that the request packet is conformed to the second-type target website, converting the request packet into an Interest packet in NDN protocol format and forwarding it to the NDN network; otherwise, forwarding the request packet directly in TCP/IP network;
when a Data packet in NDN protocol format returned after the Interest packet in NDN protocol format is forwarded to the NDN network is acquired, converting the acquired Data packet in NDN protocol format into a Data packet in IP protocol format and returning it to the client in TCP/IP network; otherwise, re-forwarding the request packet in TCP/IP network; and
when the request packet is forwarded in TCP/IP network, capturing a Data packet returned as a response of the server when the request packet is forwarded in TCP/IP network; and returning the returned Data packet to the client, converting the returned Data packet into a Data packet in NDN protocol format and buffering it locally on a nearest NDN node.

7. An apparatus for content management and control of a hybrid network of NDN and IP, comprising:
an NDN/IP gateway configured for capturing a request packet sent by a client in TCP/IP network; performing deep packet inspection of application layer on the request packet to determine whether the request packet is conformed to a first-type target website; determining the name of replacement content according to a pre-established naming mapping table when it is determined that the request packet is conformed to the first-type target website, wherein the replacement content is used for replacing requested content of the request packet in TCP/IP network; and forwarding the request packet directly in TCP/IP network when it is determined that the request packet is not conformed to the first-type target website; and
an NDN/IP conversion unit configured for generating an Interest packet in NDN protocol format according to the name of replacement content and the request content of the request packet in TCP/IP network, and forwarding it to an NDN network; acquiring a Data packet in NDN protocol format returned after the Interest packet in NDN protocol format forwarded to the NDN network; and converting the Data packet in NDN protocol format into a Data packet in IP protocol format, and returning it through the NDN/IP gateway to the client in TCP/IP network.

8. An apparatus for content management and control of a hybrid network of NDN and IP, comprising:
an NDN/IP gateway configured for capturing a content Data packet returned by a server in TCP/IP network; performing deep packet inspection on the content data packet to determine whether the content data packet is a response message returned by a first-type target website; when it is determined that the content data packet is a response message returned by a first-type target website, performing a judgment that whether the content data packet contains prohibited content; when it is determined that the content data packet contains prohibited content, determining the name of replacement content according to a pre-established name-mapping table, wherein the replacement content is used for replacing the content contained in the content data packet; and when it is determined that the content data packet is not a response message returned by the first-type target website, or it is determined that the content data packet does not contain prohibited content, returning the content data packet directly in TCP/IP network to a client in the TCP/IP network according to a destination address returned by the server; and
an NDN/IP conversion unit configured for generating an Interest packet in the format of NDN protocol according to the name of the replacement content and the content data packet, and forwarding the Interest packet to NDN network; acquiring a Data packet in the format of NDN protocol returned after the Interest packet of in the format of NDN protocol is forwarded to NDN network; and converting the Data packet in the format of NDN protocol into a Data packet in the format of IP protocol and returning it to the client in the TCP/IP network according to the destination address returned by the server.

9. The apparatus for content management and control according to claim 8, wherein the NDN/IP gate is used for capturing a video stream returned by a streaming media server in TCP/IP network.

10. A storage medium, comprising a program executable by a processor to implement the method for content management and control according to claim 1.

11. The method for content management and control according to claim 3, further comprising:
performing deep packet inspection of the application layer to the captured request packet to determine whether the request packet is conformed to a second-type target website, wherein the request packet is sent by a client in TCP/IP network;
when it is determined that the request packet is conformed to the second-type target website, converting the request packet into an Interest packet in NDN protocol format and forwarding it to the NDN network; otherwise, forwarding the request packet directly in TCP/IP network; when a Data packet in NDN protocol format returned after the Interest packet in NDN protocol format is forwarded to the NDN network is acquired, converting the acquired Data packet in NDN protocol format into a Data packet in IP protocol format and returning it to the client in TCP/IP network; otherwise, re-forwarding the request packet in TCP/IP network; and
when the request packet is forwarded in TCP/IP network, capturing a Data packet returned as a response of the server when the request packet is forwarded in TCP/IP network; and returning the returned Data packet to the client, converting the returned Data packet into a Data packet in NDN protocol format and buffering it locally on a nearest NDN node.
